(19) United States
(12) Patent Application Publication
(10) Pub. No.: US 2017/0074299 A1
(43) Pub. Date: Mar. 16, 2017

(54) BAND

(71) Applicant: Sumitomo Wiring Systems, Ltd., Yokkaichi (JP)

(72) Inventors: Sungmin LEE, Yokkaichi (JP); Hikaru OMAE, Yokkaichi (JP)

(21) Appl. No.: 15/260,846

(22) Filed: Sep. 9, 2016

(30) Foreign Application Priority Data
Sep. 11, 2015 (JP) 2015179266

(51) Int. Cl. F16B 2/08; B65D 63/00

(52) U.S. Cl. CPC F16B 2/08; B65D 63/00

(57) ABSTRACT

A band that enables preventing an extra length region of a band main body from interfering with a peripheral component or the like. The band includes a head that has a through-hole, and a band main body that extends from the head. A wrapping region that is to be wrapped around an object, an insertion region that is to be inserted into the through-hole, and an extra length region that is to be pulled out from the through-hole are successively arranged in the extending direction of the band main body. The through-hole of the head is provided with an inclined surface that orients the insertion region such that the extra length region extends from the through-hole in a direction of approaching the wrapping region.

This application claims the benefit of Japanese Application No. JP2015-179266, filed on Sep. 11, 2015, the contents of which are hereby incorporated by reference in their entirety.

### FIELD

The present invention relates to a band such as a tie band.

### BACKGROUND

JP 2003-104430A discloses a band that includes a fastening portion provided with a through-hole, and a band main body that extends from the fastening portion. The band main body is wrapped around a tying target, and the tip portion is inserted into the through-hole. The tip portion of the band main body has an extra length region that is pulled outward from the through-hole. In the state where the extra length region of the band main body has been pulled forcefully, a recession and protrusion portion of the band main body engages with a locking recession and protrusion portion of the fastening portion, and therefore the band main body is locked by the fastening portion, and the tied state of the tying target is maintained.

In the conventional band described above, when the tying target has been tied by the band main body, the extra length region of the band main body protrudes upward or diagonally upward from the fastening portion. Normally, in order to avoid interference with peripheral components and the like, this extra length region is cut so as to reduce the amount of protrusion from the fastening portion. However, there is a risk of the cut edge coming into contact with a peripheral component or the like, and the peripheral component becoming damaged.

The present design was achieved in light of the above-described situation, and an object thereof is to provide a band that enables preventing the extra length region of the band main body from interfering with a peripheral component or the like.

### SUMMARY

A band according to one aspect includes: a head that has a through-hole; and a band main body that extends from the head, wherein a wrapping region that is to be wrapped around an object, an insertion region that is to be inserted into the through-hole, and an extra length region that is to be pulled out from the through-hole are successively arranged in an extending direction of the band main body, and the through-hole of the head is provided with an inclined surface that orients the insertion region such that the extra length region extends from the through-hole in a direction of approaching the wrapping region.

The insertion region of the band main body is oriented by the inclined surface of the through-hole such that the extra length region of the band main body extends from the through-hole in a direction of approaching the wrapping region, and therefore the extra length region is not likely to interfere with a peripheral component. As a result, it is possible to prevent the peripheral component from becoming damaged.

### DRAWINGS

FIG. 1 is a perspective view of a band according to a first embodiment;

FIG. 2 is a perspective view of a state in which the band has been wrapped around an object;

FIG. 3 is a cross-sectional view of the state in FIG. 2;

FIG. 4 is a diagram showing a second embodiment and corresponds to FIG. 1;

FIG. 5 is a diagram showing the second embodiment and corresponds to FIG. 2;

FIG. 6 is a diagram showing the second embodiment and corresponds to FIG. 3;

FIG. 7 is a diagram showing a third embodiment and corresponds to FIG. 1;

FIG. 8 is a diagram showing the third embodiment and corresponds to FIG. 2;

FIG. 9 is a diagram showing the third embodiment and corresponds to FIG. 3;

FIG. 10 is a diagram showing a fourth embodiment and corresponds to FIG. 1;

FIG. 11 is a diagram showing the fourth embodiment and corresponds to FIG. 2; and

FIG. 12 is a diagram showing the fourth embodiment and corresponds to FIG. 3.

### DESCRIPTION

Preferred embodiments will be described below. The band main body may be provided with a holding portion that brings the extra length region into close contact with an outer surface of the wrapping region. According to this configuration, it is possible to more reliably prevent the extra length region from interfering with a peripheral component. Also, the state where the extra length region is in close contact with the outer surface of the wrapping region can be maintained by the holding portion.

The holding portion may have a cantilevered pressing piece that protrudes on one side of the wrapping region, and in a state where the pressing piece is folded over to an other side of the wrapping region, the pressing piece may cover an outer surface of the extra length region, and a tip portion of the pressing piece may be locked on the other side of the wrapping region. According to this configuration, there is no need to perform the task of cutting the extra length region so as to reduce the amount of protrusion thereof

The holding portion may be constituted by a tunnel portion that has a through-hole for insertion of the extra length region. According to this configuration, the state where the extra length region is in close contact with the outer surface of the wrapping region can be maintained more favorably.

The holding portion may be constituted by a pair of catching pieces that rise up on two sides of the wrapping region, and tip portions of the catching pieces may be bent inward and cover two side edge portions of the outer surface of the extra length region. According to this configuration, the extra length region can be brought into close contact with the outer surface of the wrapping region with a comparatively simple structure.

A plurality of the holding portions may be provided with gaps therebetween in the extending direction of the wrapping region. According to this configuration, the state where the extra length region is in close contact with the outer surface of the wrapping region can be maintained even more reliably.

### First Embodiment

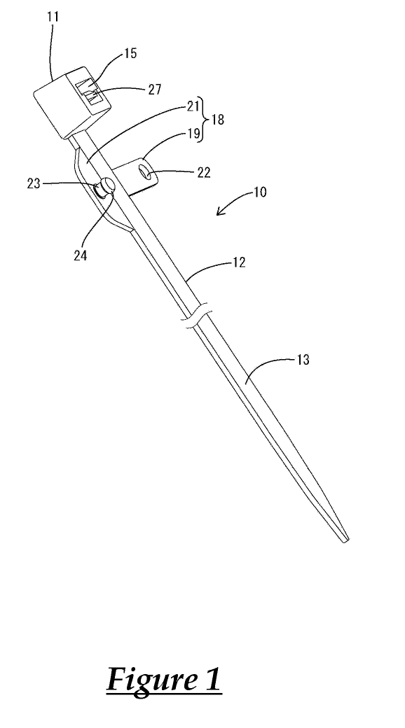

Hereinafter, a first embodiment will be described with reference to FIGS. 1 to 3. A band 10 according to the first embodiment is an example of a tie band for binding an object 60 such as an electrical wire that is routed in an automobile. The band 10 is made of a synthetic resin and is overall formed as a single body, and includes a head 11 having an approximately square block shape, and a band main body 12 that extends in a long and thin manner from an edge portion of the head 11 on the bottom surface side thereof (the side with the surface that opposes the object 60).

The band main body 12 has a band base portion 13 that is shaped as a flat belt and is connected to the head 11. The band base portion 13 has a constant width dimension with the exception of the tip portion, is formed so as to be thin, and can bend with the portion connected to the head 11 serving as the origin.

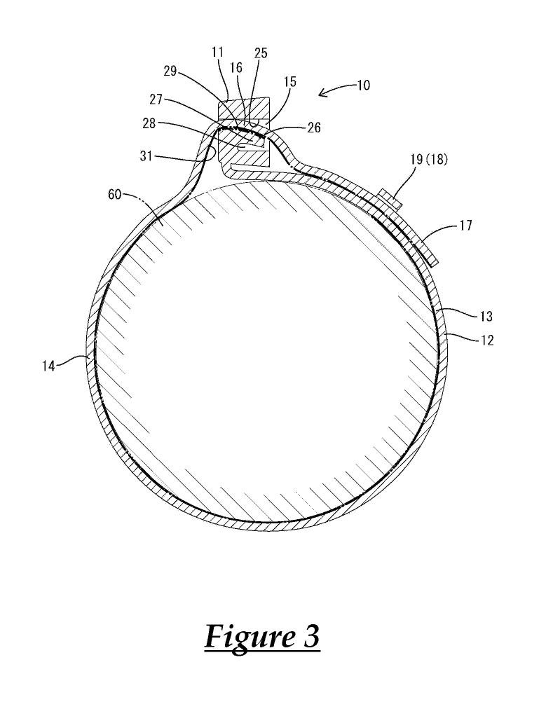

As shown in FIG. 3, the band main body 12 has a ring-shaped wrapping region 14 that is wrapped around the outer circumferential surface of the object 60, an insertion region 16 that extends from one end of the wrapping region 14, is inserted into a later-described through-hole 15 of the head 11, and is arranged inside the through-hole 15, and an extra length region 17 that is pulled out from the through-hole 15 and extends outward, and these regions are successively arranged side-by-side in the extending direction of the band main body 12.

As shown in FIG. 1, the band main body 12 has a holding portion 18 at a position in the vicinity of the head 11. The holding portion 18 is constituted by a pressing piece 19 that protrudes to one side from one side edge of the band base portion 13 (the right side edge when facing FIG. 1), and a receiving piece 21 that bulges to the other side from the other side edge of the band base portion 13 (the left side edge when facing FIG. 1) at a position on the side opposite to the pressing piece 19 with the band base portion 13 therebetween.

The pressing piece 19 is a thin belt piece that protrudes in a cantilevered manner and has the same thickness as the band base portion 13 or is thinner than the band base portion 13, and can be folded over to the other side with the portion connected to the band base portion 13 serving as the fulcrum. A circular locking hole 22 is provided so as to pass through the tip portion of the pressing piece 19.

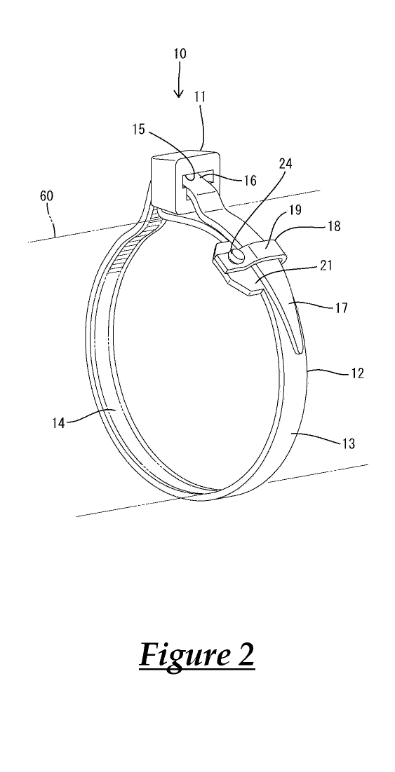

The receiving piece 21 is a protruding piece that is longer than the pressing piece 19 with respect to the extending direction of the band main body 12 and is shorter than the pressing piece 19 with respect to the width direction, and, unlike the pressing piece 19, is restricted from being folded over to the one side. A locking protrusion 23 is provided so as to protrude from the outer surface of the receiving piece 21 (the surface on the side opposite to the surface that opposes the object) at a position that is symmetrical with the locking hole 22 with the band base portion 13 therebetween. The locking protrusion 23 includes a circular column-shaped main body portion and a flange portion 24 that protrudes from the tip of the main body portion over the entire circumference thereof. As shown in FIG. 2, when the pressing piece 19 is folded over, it is arranged such that the pressing piece 19 is placed over the outer surface of the receiving piece 21, the locking protrusion 23 is elastically inserted into the locking hole 22 of the pressing piece 19, and the flange portion 24 can abut against the peripheral edge of the locking hole 22 on the outer surface of the pressing piece 19. Accordingly, the folded over state of the pressing piece 19 is maintained.

The through-hole 15 for insertion of the insertion region 16 at the tip portion of the band main body 12 is formed in the head 11. The through-hole 15 has horizontally elongated slit-shaped openings in both the front and rear surfaces of the head 11 (the end surfaces of the head 11 in the left-right direction in FIG. 3). Among the inner surfaces of the through-hole 15 of the head 11, the upper surface in FIG. 3 is a straight surface 25 that extends along the front-rear direction.

On the other hand, among the inner surfaces of the through-hole 15 of the head 11, the lower surface in FIG. 3 is a tapered inclined surface 26 that is inclined with a descending slope toward the front side (the exit side through which the extra length region 17 at the tip portion of the band main body 12 is pulled). In other words, the inclined surface 26 is inclined so as to gradually approach the wrapping region 14 of the band main body 12 as it extends toward the exit side of the through-hole 15. This inclined surface 26 is formed on a slope portion 27 that protrudes, in a cantilevered manner, diagonally downward and forward from the widthwise central portion at the rear edge of the lower surface of the through-hole 15.

As shown in FIG. 3, a gap portion 28 is provided in the head 11 on the side opposite to the through-hole 15 with the slope portion 27 therebetween. The gap portion 28 is open at the front surface of the head 11, and is a space that allows bending movement of the slope portion 27. Note that the inclined surface 26 and the straight surface 25 are provided over approximately the entire length of the head 11 in the front-rear direction.

The inclined surface 26 of the slope portion 27 is provided with a recession and protrusion portion 29 in which stripe-like receding and protruding ridges that extend in the width direction are repeatedly arranged in the inclination direction. Also, the insertion region 16 of the band main body 12 is also provided with a main body recession and protrusion portion 31 having a configuration that corresponds to the recession and protrusion portion 29. When the recession and protrusion portion 29 engages with the main body recession and protrusion portion 31, the insertion region 16 of the band main body 12 is locked to the head 11, and it is possible to maintain a state in which the band main body 12 binds the object 60.

Next, a method of using the band 10 according to the first embodiment will be described.

The wrapping region 14 of the band main body 12 is wrapped around the object 60, and then the insertion region 16 of the band main body 12 is inserted into the through-hole 15 of the head 11. As shown in FIG. 3, the insertion region 16 of the band main body 12 passes between the upper and lower surfaces of the entrance side of the through-hole 15 with substantially no gaps.

Subsequently, the extra length region 17 of the band main body 12 extending out of the exit of the through-hole 15 is pulled by hand in the direction of approaching the wrapping region 14 of the band main body 12. Accordingly, the insertion region 16 of the band main body 12 is arranged so as to extend diagonally downward (i.e., toward the side on which the wrapping region 14 is located) from the entrance of the through-hole 15 to the exit thereof along the inclined surface 26. Also, the extra length region 17 of the band main body 12 also extends continuously from the insertion region 16 in the diagonally downward direction so as to approach the wrapping region 14.

Next, the tip portion of the extra length region 17 of the band main body 12 is pulled and pressed against the wrapping region 14, and the pressing piece 19 is folded over toward the receiving piece 21 in this state. As shown in FIG. 2, the pressing piece 19 extends so as to cross over the extra length region 17 of the band main body 12, and the locking protrusion 23 of the receiving piece 21 is inserted into and locked to the locking hole 22 in the tip portion, and thus the tip portion is fixed to the receiving piece 21. Due to the pressing piece 19 being fixed to the receiving piece 21, the extra length region 17 of the band main body 12 is pressed against the outer surface of the wrapping region 14 by the pressing piece 19, and this abutting state is maintained. Also, due to the recession and protrusion portion 29 and the main body recession and protrusion portion 31 engaging with each other, the insertion region 16 of the band main body 12 is prevented from coming out of the through-hole 15 of the head 11. Here, the insertion region 16 of the band main body 12 is arranged so as to gradually approach the wrapping region 14 due to being guided by the inclined surface 26, thus making it possible to suppress the outward elastic restoration force of the extra length region 17 to a low amount, and making it possible to prevent a situation in which the pressing piece 19 inadvertently releases the locking with the receiving piece 21 when subjected to elastic restoration force from the extra length region 17.

Also, although it is possible for the tip portion of the extra length region 17 of the band main body 12 that is forward of the pressing piece 19 to slightly rise up from the outer surface of the wrapping region 14, it is directed toward the wrapping region 14 side by the inclined surface 26 and also pressed toward the wrapping region 14 side by the pressing piece 19, and thus does not greatly protrude outward from the wrapping region 14.

When the object 60 is installed at a certain location, there are cases where a peripheral component (not shown) is located at a position in the vicinity of the object 60. In such a case, if the extra length region 17 of the band main body 12 protrudes outward in a direction of separation from the wrapping region 14, there is a risk of the extra length region 17 interfering with the peripheral component, and the surface of the peripheral component becoming damaged.

However, according to the first embodiment, the insertion region 16 of the band main body 12 is oriented by the inclined surface 26 of the through-hole 15 such that the extra length region 17 of the band main body 12 extends from the through-hole 15 in a direction of approaching the wrapping region 14, and therefore the extra length region 17 does not greatly protrude outward. As a result, it is possible to prevent the extra length region 17 from interfering with the peripheral component.

Also, the band main body 12 is provided with the holding portion 18 for bringing the extra length region 17 into close contact with the outer surface of the wrapping region 14, and therefore the extra length region 17 is even less likely to interfere with the peripheral component. Moreover, the holding portion 18 makes it possible to maintain the state in which the extra length region 17 of the band main body 12 is in close contact with the outer surface of the wrapping region 14, and this holding portion 18 is molded integrally with the band base portion 13, thus making it possible to prevent an increase in the number of components.

Furthermore, the holding portion 18 has the pressing piece 19 that protrudes on one side of the wrapping region 14, and, due to the pressing piece 19 being folded over to the other side of the wrapping region 14 so as to cover the outer surface of the extra length region 17, and then the locking protrusion 23 being inserted into and locked to the locking hole 22 in this state, there is no need to perform the task of cutting the extra length region 17 so as to reduce the amount of protrusion thereof.

### Second Embodiment

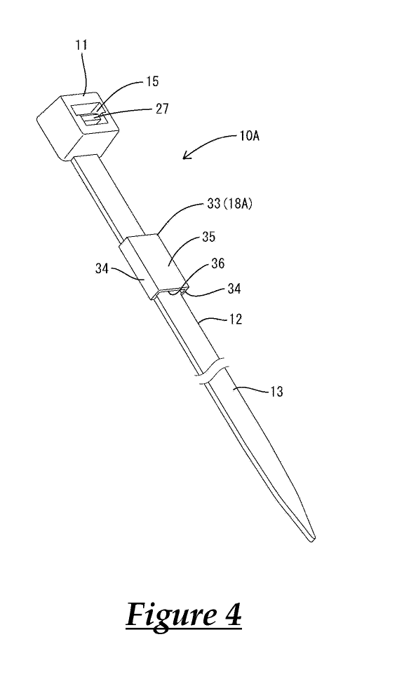

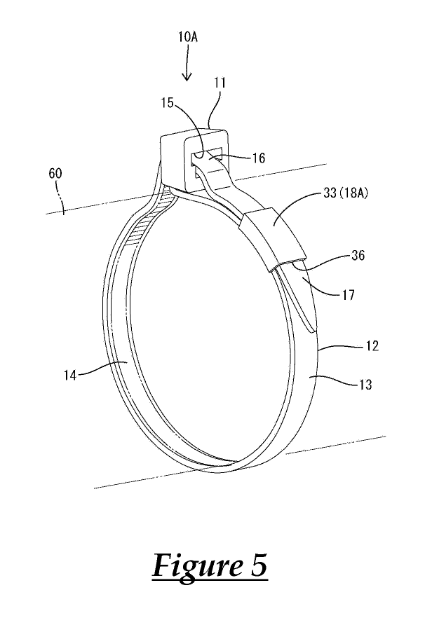

FIGS. 4 to 6 show a second embodiment. In a band 10A according to the second embodiment, the holding portion 18A is different from the first embodiment, but other aspects are similar to the first embodiment. For this reason, configurations in the second embodiment that are similar to the first embodiment are denoted by the same reference signs, and descriptions for them that would be redundant with the first embodiment will not be given.

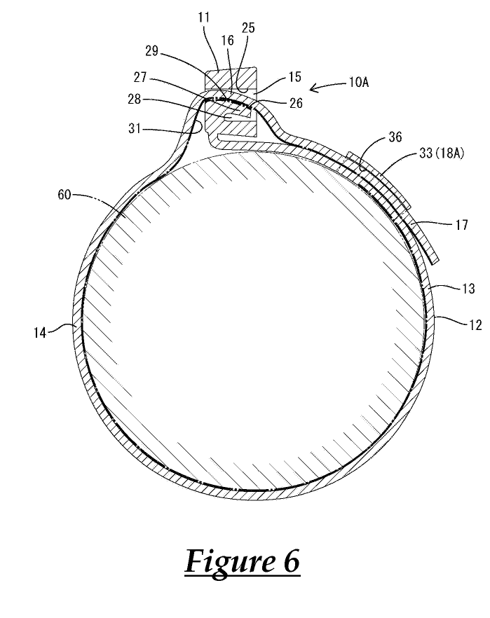

The holding portion 18A is constituted as a tunnel portion 33 provided at a position that is biased toward the head 11 of the band main body 12. As shown in FIG. 4, the tunnel portion 33 is constituted by a pair of side portions 34 that rise up a short distance outward from the two side edges of the band base portion 13 (outward in the diameter direction of the object 60), and a spanning portion 35 that connects the rising ends of the two side portions 34, and thus the tunnel portion 33 has an upside-down “U” shape overall. As shown in FIG. 6, inside the tunnel portion 33, a through-hole 36 for insertion of the extra length region 17 is defined between the tunnel portion 33 and the wrapping region 14 of the band main body 12. The through-hole 36 has a cross-sectional shape that corresponds to the extra length region 17, and the extra length region 17 is inserted into the through-hole 36 in a state where free movement is restricted.

In the case of the second embodiment, when the extra length region 17 of the band main body 12 extending out of the exit of the through-hole 15 is inserted through the through-hole 36 of the tunnel portion 33, it is maintained in a state of being in close contact with the outer surface of the wrapping region 14. In this case, the wrapping region 14 is oriented by the inclined surface 26 of the head 11 so as to extend from the exit of the through-hole 15 in the direction of approaching the wrapping region 14, and therefore the tip of the extra length region 17 more easily passes through the through-hole 36 of the tunnel portion 33, and operability can be improved.

Also, according to the second embodiment, the extra length region 17 is inserted into the through-hole 36 of the tunnel portion 33 that is fixed to the band base portion 13, and thus the state where the extra length region 17 is in close contact with the outer surface of the wrapping region 14 can be maintained more favorably.

### Third Embodiment

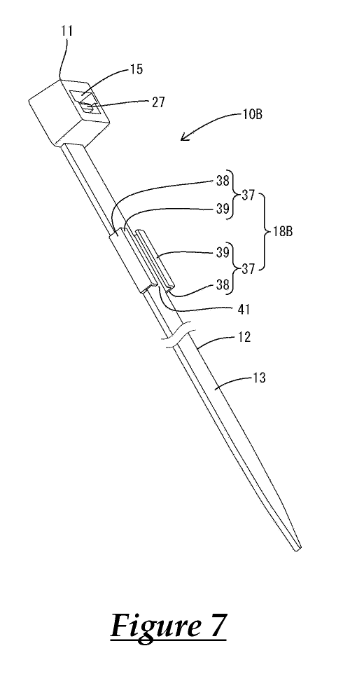

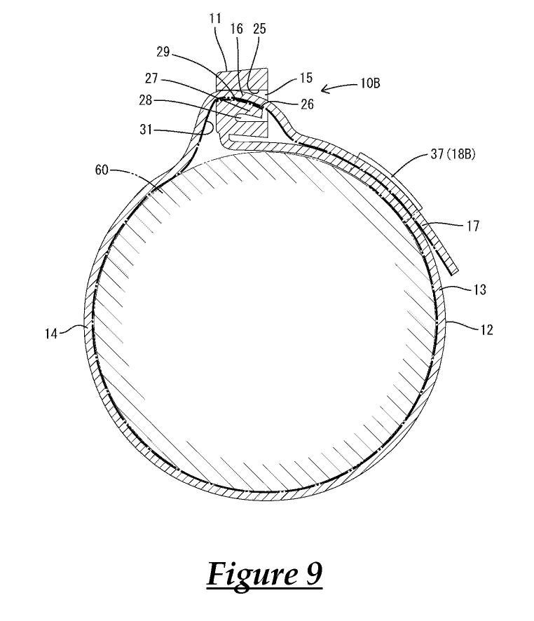

FIGS. 7 to 9 show a third embodiment. In a band 10B according to the third embodiment as well, a holding portion 18B is different from the first embodiment, but other aspects are similar to the first embodiment. For this reason, configurations in the third embodiment that are similar to the first embodiment are denoted by the same reference signs, and descriptions for them that would be redundant with the first embodiment will not be given.

As shown in FIG. 7, the holding portion 18B is constituted as a pair of catching pieces 37 that are provided at positions biased toward the head 11 on the band main body 12. The two catching pieces 37 are constituted by a pair of rising piece portions 38 that rise a short distance outward from the two side edges of the band base portion 13 (outward in the diameter direction of the object 60), and latching piece portions 39 that protrude inward toward each other from the rising ends of the two rising piece portions 38, and thus the two catching pieces 37 are each approximately shaped as an “L”. A clearance 41 that is smaller than the width dimension of the extra length region 17 of the band main body 12 is defined between the two catching pieces 37.

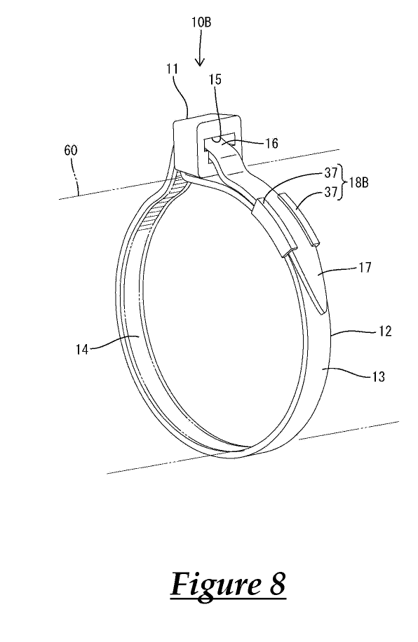

In the case of the third embodiment, as shown in FIG. 8, the two side edge portions of the extra length region 17 of the band main body 12 extending out of the exit of the through-hole 15 are inserted inward of the latching piece portions 39 of the two catching pieces 37. In this case, a configuration is possible in which the two catching pieces 37 are bent, and then the two side edge portions of the extra length region 17 are fitted between the latching piece portions 39 of the two catching pieces 37. Accordingly, the rising piece portions 38 of the two catching pieces 37 cover the two side edge portions of the extra length region 17 of the band main body 12, and the extra length region 17 abuts against the outer surface of the wrapping region 14 in a state where free movement is restricted.

According to the third embodiment, the extra length region 17 can be brought into close contact with the outer surface of the wrapping region 14 with a simpler structure compared to the holding portion of the first embodiment.

### Fourth Embodiment

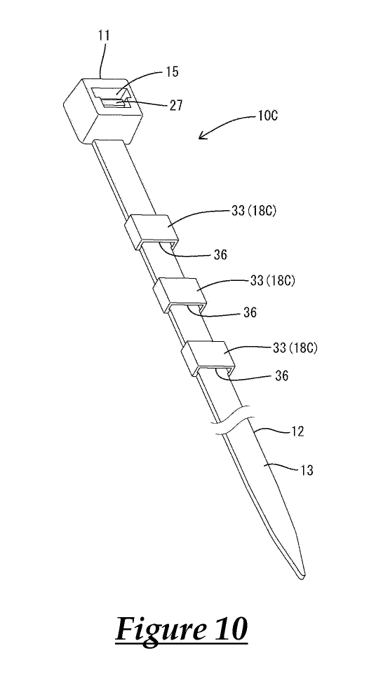

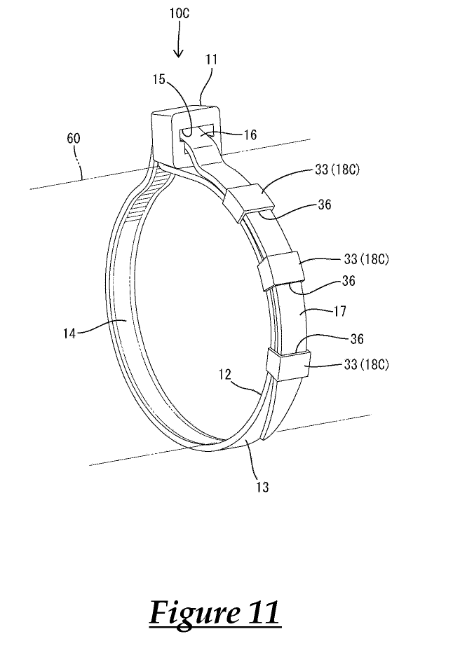

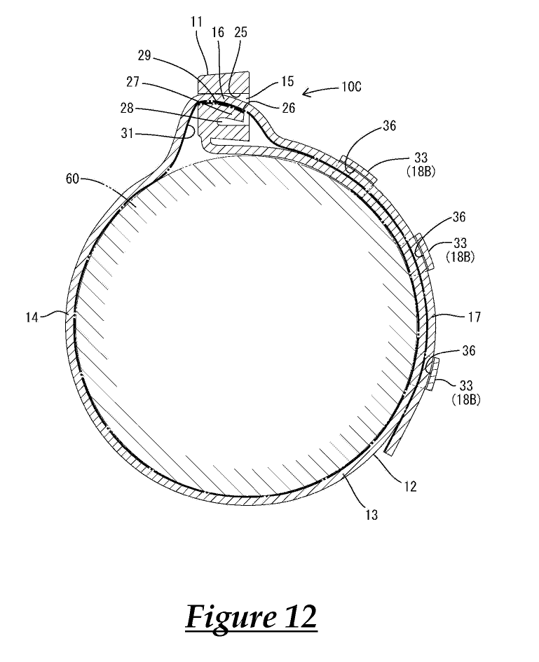

FIGS. 10 to 12 show a fourth embodiment. A band 10C according to the fourth embodiment is provided with multiple holding portions that have the same shape as the tunnel portion 33 of the second embodiment and are arranged with gaps therebetween in the extending direction of the band main body 12. Similarly to the first to third embodiments, the holding portions are each integrally connected to the band base portion 13, and are aligned at positions biased toward the head 11. The extra length region 17 of the band main body 12 extending out of the exit of the through-hole 15 is successively inserted into the through-holes 36 of the holding portions. Consequently, according to the fourth embodiment, the state where the extra length region 17 is in close contact with the outer surface of the wrapping region 14 can be maintained even more reliably.

### Other Embodiments

The following is a brief description of other embodiments.

The holding portion of the band may be omitted. In this case as well, as long as the insertion region of the band main body is arranged along the inclined surface, and the extra length region of the band main body extends in the direction of approaching the wrapping region, it is possible to prevent the extra length region from interfering with a peripheral component.

A configuration is possible in which both the upper and lower inner surfaces of the through-hole are configured as inclined surfaces, and the insertion region is arranged so as to be sandwiched between these two inclined surfaces.

A configuration is possible in which the gap portion is not formed in the head, and the gap portion is solid.

The holding portion of the first and third embodiments may also be provided at multiple locations with gaps therebetween in the extending direction of the band main body as in the fourth embodiment.

The head may be provided with a fixing portion such as an elastic claw that is to be fixed to a vehicle or the like.

The object is not limited to being one electrical wire, and a configuration is possible in which it is made up of multiple electrical wires, and the electrical wires are bundled by the band. Also, the object may be a component other than an electrical wire, for example, and multiple components may be bound together by the band.

The extra length region may be cut to a desired length.

In the first embodiment, a configuration is possible in which the locking protrusion of the receiving piece is inserted into and locked to the locking hole of the pressing piece, and thereafter the extra length region of the band main body is inserted between the pressing piece and the wrapping region.

Conversely to the first embodiment, a configuration is possible in which the locking hole is provided in the receiving piece, and the locking protrusion is provided on the pressing piece.

Conversely to the first embodiment, the slope portion may be configured so as to extend, in a cantilevered manner, diagonally upward and rearward from the rear edge of the lower surface of the through-hole.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A band comprising:
a head that has a through-hole; and
a band main body that extends from the head,
wherein a wrapping region that is to be wrapped around an object, an insertion region that is to be inserted into the through-hole, and an extra length region that is to be pulled out from the through-hole are successively arranged in an extending direction of the band main body, and
the through-hole of the head is provided with an inclined surface that orients the insertion region such that the extra length region extends from the through-hole in a direction approaching the wrapping region.

2. The band according to claim 1, wherein the band main body is provided with a holding portion that brings the extra length region into close contact with an outer surface of the wrapping region.

3. The band according to claim 2, wherein the holding portion has a cantilevered pressing piece that protrudes on one side of the wrapping region, and in a state where the pressing piece is folded over to an other side of the wrapping region, the pressing piece covers an outer surface of the extra length region, and a tip portion of the pressing piece is locked on the other side of the wrapping region.

4. The band according to claim 2, wherein the holding portion is constituted by a tunnel portion that has a through-hole for insertion of the extra length region.

5. The band according to claim 2, wherein the holding portion is constituted by a pair of catching pieces that rise up on two sides of the wrapping region, and tip portions of the catching pieces are bent inward and cover two side edge portions of the outer surface of the extra length region.

6. The band according to claim 2, wherein a plurality of the holding portions are provided with gaps therebetween in the extending direction of the wrapping region.
